(19) United States
(12) Patent Application Publication
(10) Pub. No.: US 2013/0288215 A1
(43) Pub. Date: Oct. 31, 2013

(54) METHODS FOR USING VIRTUAL PATIENT MEDICAL DATA IN EDUCATION, DIAGNOSIS AND TREATMENT

(71) Applicant: The Methodist Hospital Research Institute, Houston, TX (US)

(72) Inventors: Edward Brian Butler, Houston, TX (US); Craig Peter Fischer, Houston, TX (US)

(21) Appl. No.: 13/804,680

(22) Filed: Mar. 14, 2013

Related U.S. Application Data
(63) Continuation of application No. 12/678,944, filed on Sep. 20, 2011.
(60) Provisional application No. 60/974,238, filed on Sep. 21, 2007.

(51) Int. Cl. G09B 23/28; G06F 19/00

(52) U.S. Cl. CPC G09B 23/28; G06F 19/3437
USPC 434/267; 703/11

(57) ABSTRACT

Systems, methods and apparatuses for generating and using representations of individual or aggregate human medical data.

### CROSS REFERENCE TO RELATED APPLICATIONS

The present application claims the benefit of the filing date of U.S. provisional patent application Ser. No. 60/974,238, filed on Sep. 21, 2007, the disclosure of which is incorporated herein by reference.

### BACKGROUND OF THE INVENTION

This invention relates to computer generated representations of individual or aggregate human medical data.

### BRIEF DESCRIPTION OF THE DRAWINGS

FIG. 1 illustrates a schematic view of a network system for an exemplary embodiment;

FIG. 2 illustrates a block diagram of a computer system for an exemplary embodiment;

FIG. 3 illustrates a diagram of a patient medical database for an exemplary embodiment;

FIG. 4 illustrates a block diagram of at least one processor engine within the computer system for an exemplary embodiment;

FIG. 5 illustrates a flowchart of a method for generating and displaying a representation of individual or aggregate human medical data for an exemplary embodiment;

FIG. 6A illustrates three cross sections of an anatomical structure for an exemplary embodiment;

FIG. 6B illustrates the first cross section of the anatomical structure shown in FIG. 6A for an exemplary embodiment;

FIG. 6C illustrates the second cross section of the anatomical structure shown in FIG. 6A for an exemplary embodiment;

FIG. 6D illustrates the third cross section of the anatomical structure shown in FIG. 6A for an exemplary embodiment;

FIG. 7 illustrates a perspective view of a representation of individual or aggregate human medical data having a highlighted anatomical structure for an exemplary embodiment;

FIG. 8 illustrates a flowchart of a method for generating and displaying a representation of individual or aggregate human medical data, wherein a pointer is used to display at least one patient medical data for an exemplary embodiment;

FIG. 9 illustrates a perspective view of a representation of individual or aggregate human medical data having at least one distinguishable anatomical structure with a pointer located on top of the distinguishable anatomical structure for an exemplary embodiment;

FIG. 10 illustrates a flowchart of a method for generating and displaying a representation of individual or aggregate human medical data, wherein a pointer is used to access at least one patient medical data for an exemplary embodiment;

FIG. 11 illustrates a pictorial view of a display screen showing accessible patient medical data for an exemplary embodiment;

FIG. 12 illustrates a flowchart of a method for generating and displaying a representation of individual or aggregate human medical data, wherein additional patient medical data stored at a remote location is accessed via a communications device for an exemplary embodiment;

FIG. 13 illustrates a flowchart of a method for generating and displaying a representation of individual or aggregate human medical data, wherein additional patient medical data is accessible from a website via a communications device and the medical provider may upload additional patient medical data for an exemplary embodiment;

FIG. 14A illustrates a screenshot of a graphical user interface for an exemplary embodiment;

FIG. 14B illustrates a screenshot of a graphical user interface for an exemplary embodiment;

FIG. 14C illustrates a screenshot of a graphical user interface for an exemplary embodiment;

FIG. 14D illustrates a screenshot of a graphical user interface for an exemplary embodiment;

FIG. 14E illustrates a screenshot of a graphical user interface for an exemplary embodiment;

FIG. 15 illustrates a flowchart of a method for generating and displaying a representation of individual or aggregate human medical data, wherein the representation may be used for simulating surgery for an exemplary embodiment;

FIG. 16 illustrates a perspective view of a representation of individual or aggregate human medical data showing a surgical tool and a positioning locator device comprising a scope for an exemplary embodiment;

FIG. 17 illustrates a flowchart of a method for generating and displaying a representation of individual or aggregate human medical data, wherein the representation may be used for performing surgery for an exemplary embodiment; and

FIG. 18 illustrates a flowchart of a method for generating and displaying a representation of individual or aggregate human medical data for an exemplary embodiment.

FIGS. 19a and 19b are illustrations of an exemplary embodiment of a dynamic graphical user interface.

FIG. 20 is a flow chart illustration of an exemplary embodiment of a method for identifying anatomical structures in a CT scan.

FIG. 21 is an illustration of an exemplary embodiment of a CT scan processed in accordance with the method of FIG. 20.

### DETAILED DESCRIPTION OF THE INVENTION

Medical providers are continuously searching for ways to improve the service they provide to their patients. In today's medical provider-patient relationship, it is important for medical providers to have access to prior and recent medical information located at their own facility as well as remote facilities, to have access to a variety of tools in aiding the diagnosis and treatment of their patient's ailments, and to have patients be involved in their own treatment and well-being.

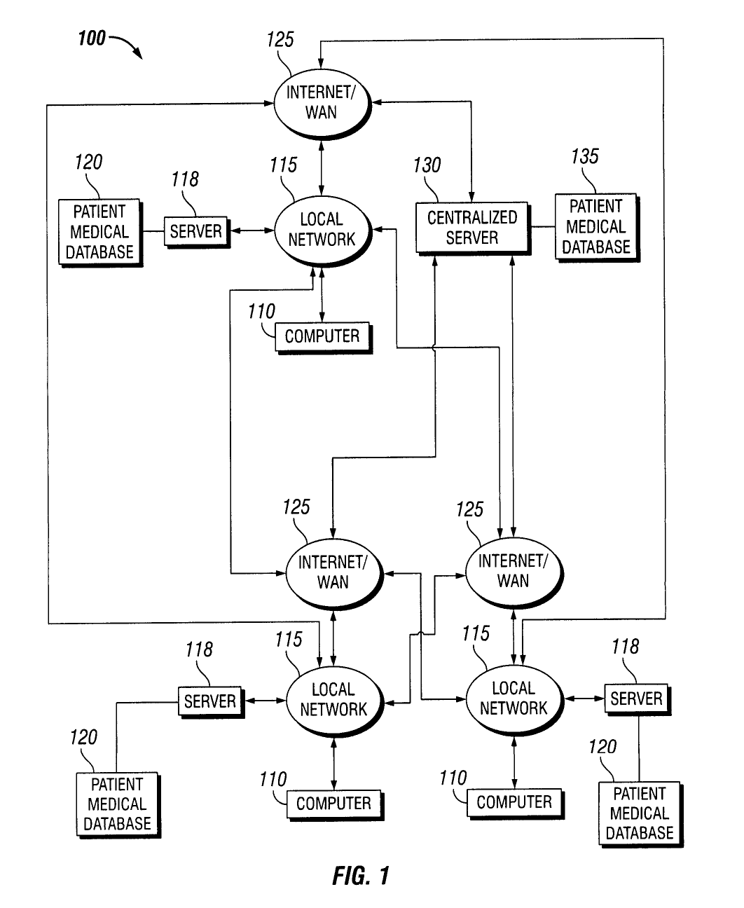

FIG. 1 illustrates a schematic view of a network system used for an exemplary embodiment. The network system 100 comprises multiple computers 110 located at remote areas that may each be connected to one or more local networks 115. Each local network 115 may be connected to a server 118 having a corresponding patient medical database 120. The computer 110 may also be connected to the internet/WAN 125 via a communications device (not shown) so that the computer 110 may connect to other remote local networks 115 for accessing the patient medical database 120 associated with that remote local network 115. This access ensures that the medical provider will have a greater amount of patient medical data so as to improve diagnosis and treatment. In an exemplary embodiment, there may also be a centralized server 130 having at least one centralized patient medical database 135. It is envisioned that the at least one centralized patient medical database 135 may store the entire patient medical data for a specific patient, wherein medical providers may upload scans, diagnostic results and any other medically related information. This network system 100 may help prevent or reduce the amount of duplicative diagnostic tests being performed and thereby reduce healthcare costs. Each computer 110 having access to the internet/WAN 125 may also have access to these remote local networks 115 and/or the centralized server 130 with the proper passwords.

Although FIG. 1 illustrates a full network system 100 comprising of multiple computers 110, local networks 115 connected to the server 118 having the corresponding patient medical database 120, a communications device for connecting to remote local networks 115 and the centralized server 130 comprising at least one centralized patient medical database 135, it should be understood that the computer 110 may generate a representation of individual or aggregate human medical data independent of the network system 100 without departing from the scope and spirit of the exemplary embodiment. This representation may include, but is not limited to, images, documents, charts and graphs. It should also be understood that that the communications device used for accessing the internet/WAN 125 may connect only to the centralized server 130 or only to other remote local networks 115, without departing from the scope and spirit of the exemplary embodiment. Further, it should be understood that a computer 110 not connected to a local network 115 may access remote local networks 115 and/or the centralized server 130 via a communications device capable of accessing the internet/WAN 125 without departing from the scope and spirit of the exemplary embodiment.

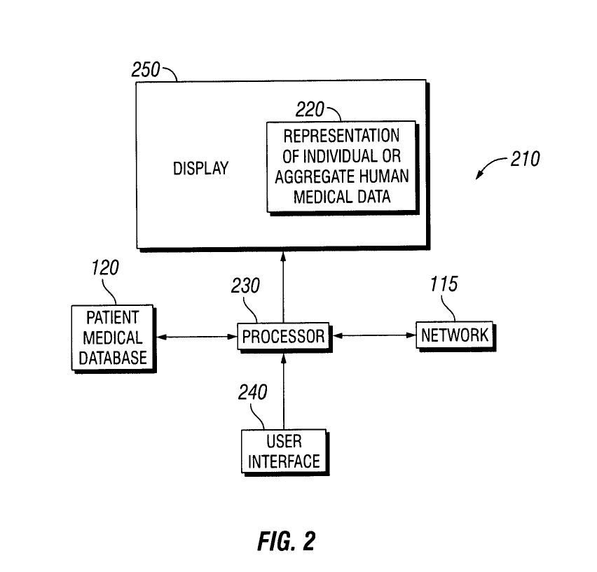

As shown in FIG. 2, an exemplary embodiment disclosed hereinbelow describes a representation of individual or aggregate human medical data generation system 210 specifically designed to generate a representation of individual or aggregate human medical data image 220 that comprises a representation of one or more anatomical structures for a particular patient and the approximate location of the one or more anatomical structures with respect to the other anatomical structures. The representation of individual or aggregate human medical data generation system 210 comprises a patient medical database 120, a processor 230, a network 115, a user interface 240, and a display 250.

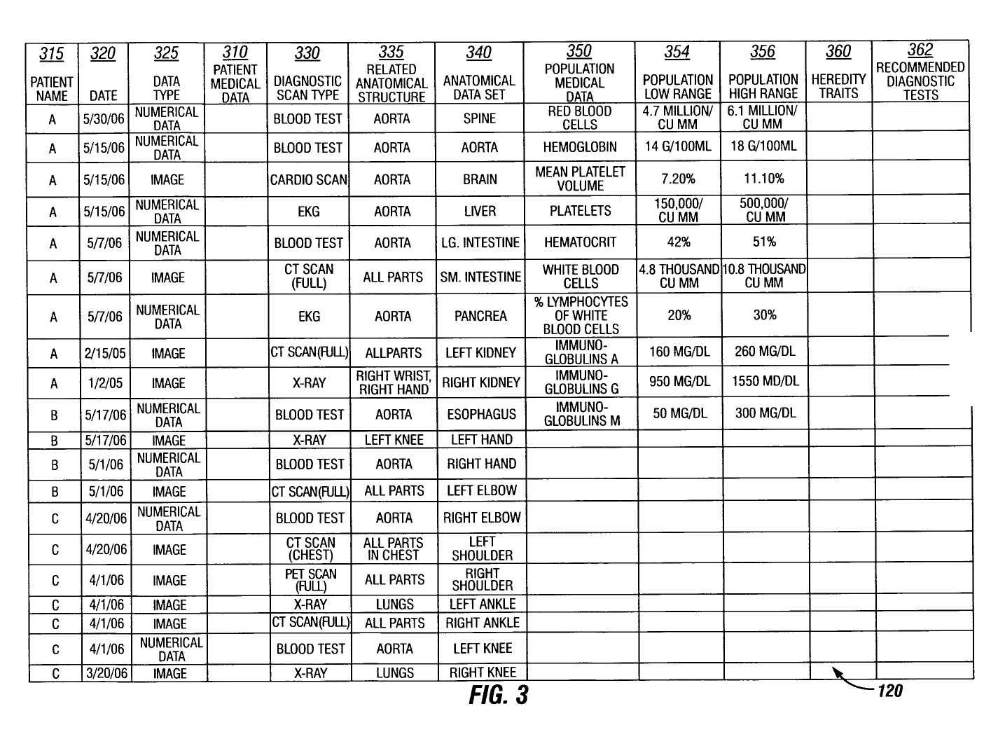

FIG. 3 illustrates a diagram of a patient medical database for an exemplary embodiment. The patient medical database 120 comprises at least one patient medical data 310 for at least one patient. The patient medical data 310 may be categorized within one or more categories comprising blood tests, cardio scans, EKG, CT scans, x-rays, PET scans, patient history, presenting symptoms, phenotype information, demographic information, biometric information, specific tumor markers and genetic profile. It should be understood that although the categories have been listed as comprising blood tests, cardio scans, EKG, CT scans, x-rays, PET scans, patient history, presenting symptoms, phenotype information, demographic information, biometric information, specific tumor markers and genetic profile, other results obtained from any diagnostic test may also be included as a category for the at least one patient medical data 310 without departing from the scope and spirit of the exemplary embodiment. This at least one patient medical data 310 may be normalized in the patient medical database 120 so that it may be accessed, used and/or manipulated by a common set of applications. This at least one patient medical data 310 may be used for generating the representation of individual or aggregate human medical data that is specific to the patient. Additionally, the phenotype information may be linked to the genetic profile thereby creating a genetic map.

The patient medical database 120 may be organized such that the at least one patient medical data 310 is associated with one or more categories comprising a patient name 315, a date 320, a data type 325, a diagnostic scan type 330 and a related anatomical structure 335. It is envisioned that the at least one patient medical data 310 may be associated with alternative categories without departing from the scope and spirit of the exemplary embodiment Furthermore, the at least one patient medical data 310 may be primarily sortable via the patient name 315, the date 320, the data type 325, the diagnostic scan type 330 or the related anatomical structure 335 and additionally sortable via any one of the remaining associated categories. As illustrated in FIG. 3, the at least one patient medical data 310 is primarily sorted alphabetically via the patient name 315 and secondarily sorted via the date 320 from the most recent to the oldest.

The patient name 315 comprises the full patient name including first name, last name and middle name. It should be understood that although this embodiment depicts the patient name comprising the full patient name, the patient name may comprise any patient identifying information, including social security number or patient number, without departing from the scope and spirit of the exemplary embodiment.

The date 320 comprises the date that the at least one patient medical data 310 was obtained or analyzed. The data type 325 indicates the nature of the at least one patient medical data 310, whether it is an image or a numerical data. The diagnostic scan type 330 further indicates the nature of the at least one patient medical data 310 by categorizing the at least one patient medical data 310 via blood tests, cardio scans, EKG, CT scans, x-rays, PET scans, patient history, presenting symptoms, phenotype information, demographic information, biometric information, specific tumor markers and genetic profile and/or any other image or numerical data resulting from diagnostic tests. The related anatomical structure 335 indicates the anatomical structure that the at least one patient medical data 310 relates to. It should be understood that the terms used in FIG. 3 are only representative terms, but that any term, i.e. picture or scan in lieu of image, may be used without departing from the scope and spirit of the exemplary embodiment

The patient medical database 120 may also comprise an anatomical data set 340, which is a library of anatomical data that may be used for identifying and labeling the at least one anatomical structures obtained from a scan of a specific patient. The patient medical database 120 may also comprise a population medical data 350 associated with a population low range 354 and a population high range 356. This population medical data 350 may be used for comparing with actual patient medical data 310 and identifying anatomical structures that have associated data that fall below the population low range 354 or above the population high range 356. Although this embodiment uses the population low range 354 and the population high range 356 for determining abnormal patient medical data, other methods may be used, e.g. using a standard deviation of approximately two (2) from the population normal or average.

The patient medical database 120 may also comprise at least one hereditary trait 360 for the specific patient. Furthermore, the patient medical database 120 may comprise a recommended diagnostic test 362 that is associated with the at least one hereditary trait and the at least one patient medical data 310. The patient medical database 120 may also comprise a list of diagnosis 365 for assisting the medical provider in properly diagnosing the patient's ailment. The patient medical database 120 may further comprise a best plan of care 370 for assisting the medical provider in determining the proper treatment. Although not illustrated in FIG. 3, the patient medical database 120 may also comprise categories including phenotypic information, patient history and presenting symptoms. It should be understood that the patient medical database 120 may comprise more or less information without departing from the scope and spirit of the exemplary embodiment.

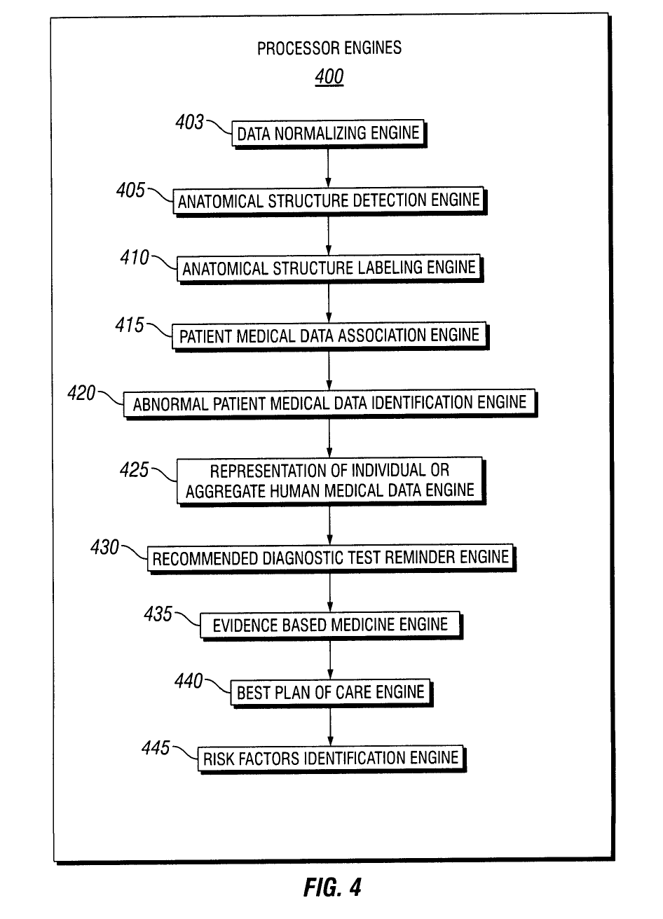

FIG. 4 illustrates a block diagram of at least one processor engine 400 within the computer system for an exemplary embodiment. As shown in this embodiment, the at least one processor engine 400 comprises a data normalizing engine 403, an anatomical structure detection engine 405, an anatomical structure labeling engine 410, a patient medical data association engine 415, an abnormal patient medical data identification engine 420, a representation of individual or aggregate human medical data engine 425, a recommended diagnostic test reminder engine 430, an evidence based medicine engine 435, a best plan of care engine 440, and a risk factors identification engine 445. The at least one processor engine 400 may be viewed as those engines which assist in generating the representation of individual or aggregate human medical data and those engines which assist the medical provider in diagnosing and treating the patients' ailments.

The processor engines 400 which assist in generating the representation of individual or aggregate human medical data comprise the data normalizing engine 403, the anatomical structure detection engine 405, the anatomical structure labeling engine 410, the patient medical data association engine 415, the abnormal patient medical data identification engine 420, and the representation of individual or aggregate human medical data engine 425. Referring to FIGS. 3 and 4, the data normalizing engine 403 normalizes the patient medical data 310 such that it may be available to a common set of applications and may store the normalized data within the patient medical database 120. Thus, whether the data is generated from blood tests, cardio scans, EKG, CT scans, x-rays, PET scans, patient history, presenting symptoms, phenotype information, demographic information, biometric information, specific tumor markers or genetic profile, a variety of applications may make use of the normalized data. The anatomical structure detection engine 405 analyzes a normalized CT scan from the patient medical database 120 and detects the at least one anatomical structure illustrated within the normalized CT scan. The anatomical structure labeling engine 410 compares the at least one anatomical structure illustrated within the normalized CT scan with the anatomical data set 340 stored within the patient medical database 120 to identify and automatically label the at least one anatomical structure illustrated within the normalized CT scan. The patient medical data association engine 415 associates the appropriate at least one patient medical data 310 to each of the related at least one anatomical structure. The abnormal patient medical data identification engine 420 compares the at least one patient medical data 310 from the patient medical database 120 to the population medical data 350 and identifies at least one patient medical data 310 as being abnormal if the patient medical data 310 either falls below the population low range 354 or above the population high range 356. The representation of individual or aggregate human medical data engine 425 generates an interactive representations of individual or aggregate human medical data image 220 (FIG. 2) that is specific to the patient and automatically labels the at least one anatomical structure. Hence, the location of each anatomical structure within the representation of individual or aggregate human medical data image 220 (FIG. 2) is an approximate location of each anatomical structure within the actual patient. It should be understood that there may be engines that perform multiple tasks or that there may be multiple engines that perform a single task without departing from the scope and spirit of the exemplary embodiment. Additionally, it should be understood that there may be additional engines used for creating the representation of individual or aggregate human medical data without departing from the scope and spirit of the exemplary embodiment. Furthermore, although the exemplary embodiment illustrates the data normalizing engine to normalize the patient medical data and then store it in the patient medical database, the data normalization may occur while the data is extracted from the patient medical database without departing from the scope and spirit of the exemplary embodiment. Thus, the normalized data is not stored within the patient medical database.

The processor engines 400 which aid the medical provider in diagnosing and treating the patients' ailments comprise the recommended diagnostic test reminder engine 430, the evidence based medicine engine 435, the best plan of care engine 440, and the risk factors identification engine 445. Referring to FIGS. 3 and 4, the recommended diagnostic test reminder engine 430 determines the recommended diagnostic tests 362 that should be performed on the patient based upon the hereditary traits 360 and the at least one patient medical data 310 associated with the patient. Additionally, the recommended diagnostic test reminder engine 430 determines when the recommended diagnostic test 362 should be performed. The evidence based medicine engine 435 reviews at least one possible treatment option and evaluates the risks and benefits for each of the at least one possible treatment option. The evidence based medicine engine 435 also predicts the outcome for each of the at least one possible treatment option. The best plan of care engine 440 reviews the results obtained from the evidence based medicine engine 435 and selects the best plan of care. The risk factors identification engine 445 identifies potential risk factors based upon the at least one patient medical data 310. It should be understood that there may be engines that perform multiple tasks or that there may be multiple engines that perform a single task without departing from the scope and spirit of the exemplary embodiment. Additionally, it should be understood that there may be additional engines used for assisting the medical provider in diagnosing and treating the patients' ailments without departing from the scope and spirit of the exemplary embodiment.

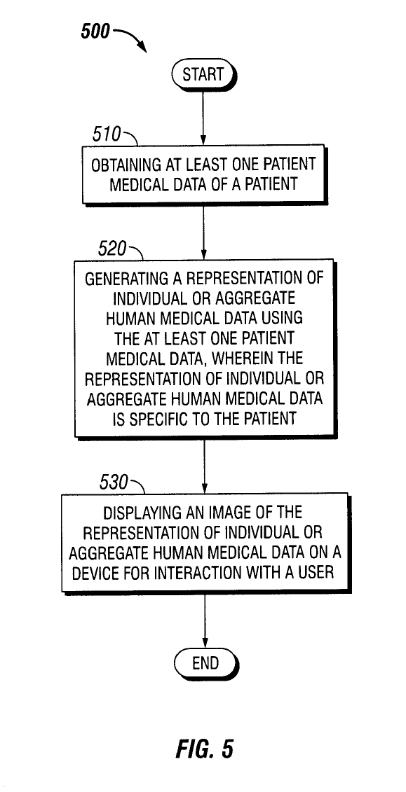

FIG. 5 illustrates a flowchart of a method 500 for generating and displaying a representation of individual or aggregate human medical data for an exemplary embodiment. At step 510, at least one patient medical data of a patient is obtained. A patient may undergo at least one diagnostic test wherein at least one patient medical data, which comprises a CT scan of at least one anatomical structure, is stored within a patient medical database. As described previously, this patient medical database may be stored locally on the computer hard drive, stored at a remote location, or a combination of being stored locally and remotely. To generate a full bodied representation of individual or aggregate human medical data, a full body CT scan and at least one imaging modality is recommended for being at least one patient medical data.

At step 520, a representation of individual or aggregate human medical data is generated using the at least one patient medical data, wherein the representation of individual or aggregate human medical data is specific to the patient. The representation of individual or aggregate human medical data is generated by a processor comprising one or more processor engines, which are illustrated in FIG. 4. The engines involved in generating the representation of individual or aggregate human medical data comprise the data normalizing engine, the anatomical structure detection engine, the anatomical structure labeling engine, and the representation of individual or aggregate human medical data engine. As described previously, the data normalizing engine may normalize the at least one patient medical data either prior to being stored within the patient medical database or at the time of its use. According to this embodiment, the anatomical structure detection engine analyzes a full body CT scan that is stored in the patient medical database and detects the at least one anatomical structure illustrated within the full body CT scan. Although this embodiment uses a full body CT scan to generate the representation of individual or aggregate human medical data, it should be understood that one or more CT scans of a particular anatomical structure may be combined to generate the representation of individual or aggregate human medical data.

There are two methods that the anatomical structure detection engine 405 uses for detecting the at least one anatomical structure illustrated within the CT scan having a one or more cross section images.

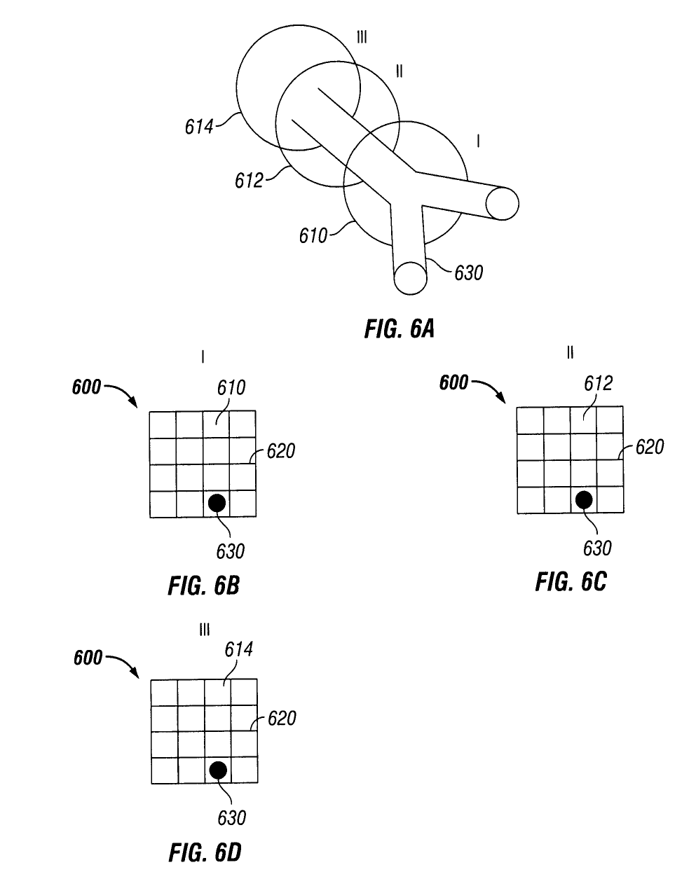

The first method involves a grid system 600, which is illustrated in FIGS. 6A-6D. The anatomical structure detection engine creates a grid 620 comprising a number of columns by a number of rows for each of the one or more cross section images. FIG. 6A illustrates three cross sections of an anatomical structure 630 for an exemplary embodiment. FIG. 6B illustrates the first cross section 610 of the anatomical structure 630 shown in FIG. 6A for an exemplary embodiment. The anatomical structure 630 is shown as being located in the third column and fourth row. FIG. 6C illustrates the second cross section 612 of the anatomical structure 630 shown in FIG. 6A for an exemplary embodiment. Again, the anatomical structure 630 is shown as being located in the third column and fourth row. FIG. 6D illustrates the third cross section 614 of the anatomical structure 630 shown in FIG. 6A for an exemplary embodiment. Again, the anatomical structure 630 is shown as being located in the third column and fourth row. The anatomical structure detection engine detects the anatomical structure 630 because it is located in substantially the same grid location on each of the cross section images 610, 612, 614. Although the location may change slightly from one cross section to the next cross section, the anatomical structure detection engine keeps track of the distance and how the anatomical structure 630 moves throughout the one or more cross section images 610, 612, 614.

The second method that the anatomical structure detection engine 405 may use for detecting the at least one anatomical structure illustrated within the CT scan is by measuring the density units of the various locations across the cross section images. The density units may be measured using Houndsfield units. As the density changes along the cross section images, the anatomical structure detection engine detects the density change and identifies the at least one anatomical structure illustrated within the CT scan. Additionally, the grid method may be used in combination with the density method for ascertaining the relative position of the at least one anatomical structure.

Once the anatomical structure detection engine 405 detects the various anatomical structures, the anatomical structure labeling engine compares the at least one anatomical structure illustrated within the CT scan with the anatomical data set, which is stored within the patient medical database, to identify and label the at least one anatomical structure illustrated.

The representation of individual or aggregate human medical data patient engine generates an interactive representation of individual or aggregate human medical data that is specific to the patient. The location of each anatomical structure within the representation of individual or aggregate human medical data is approximate to the locations of each anatomical structure within the patient.

Additionally, the processor may further comprise the patient medical data association engine 415. The patient medical data association engine 415 associates the at least one patient medical data located within the patient medical database to each of the related at least one anatomical structure that were identified.

Moreover, the processor may further comprise the abnormal patient medical data identification engine 420. The abnormal patient medical data identification engine 420 compares the at least one patient medical data from the patient medical database to the population medical data and identifies a portion of the at least one patient medical data as being abnormal if the portion of the at least one patient medical data either falls below the population low range or above the population high range. As previously discussed, the abnormal patient medical data may be identified by other methods, i.e. if the patient medical data is beyond approximately two (2) standard deviations from the population normal or average.

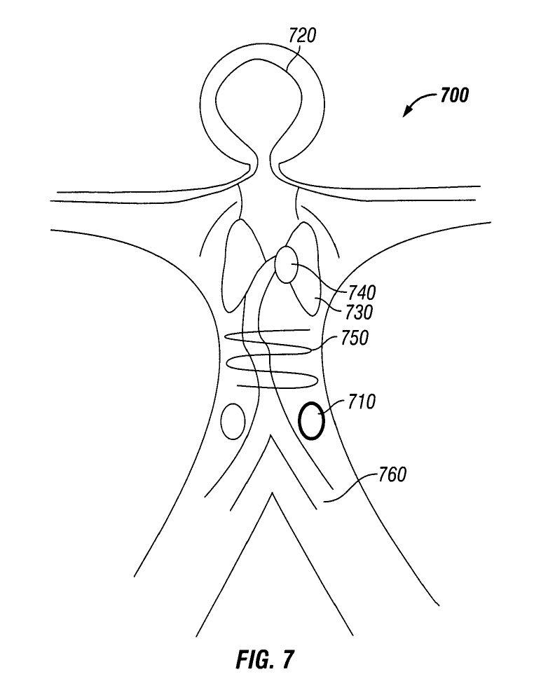

At step 530, the representation of individual or aggregate human medical data image is displayed on a device for interaction with a user. FIG. 7 illustrates a perspective view of a representation of individual or aggregate human medical data 700 having a highlighted anatomical structure 710 for an exemplary embodiment. The highlighted anatomical structure 710 informs the medical provider that there is at least one abnormal patient medical data associated with that highlighted anatomical structure 710. The medical provider may then analyze the reasons for the highlighted anatomical structure 710. As shown in this embodiment, the representation of individual or aggregate human medical data 700 may comprise at least one anatomical structure comprising the brain 720, the lungs 730, the aorta 740, the kidneys 710, the intestines 750, and the lymphatic system 760. Although this embodiment shows only the brain 720, the lungs 730, the aorta 740, the kidneys 710, the intestines 750, and the lymphatic system 760, it should be understood that all anatomical structures may be represented in the representation of individual or aggregate human medical data 700. Furthermore, although FIG. 7 illustrates the representation of individual or aggregate human medical data in two-dimensions, the representation of individual or aggregate human medical data may also be viewed in three-dimensions. In an alternative embodiment, the representation of individual or aggregate human medical data is displayed in a holographic, three-dimensional view.

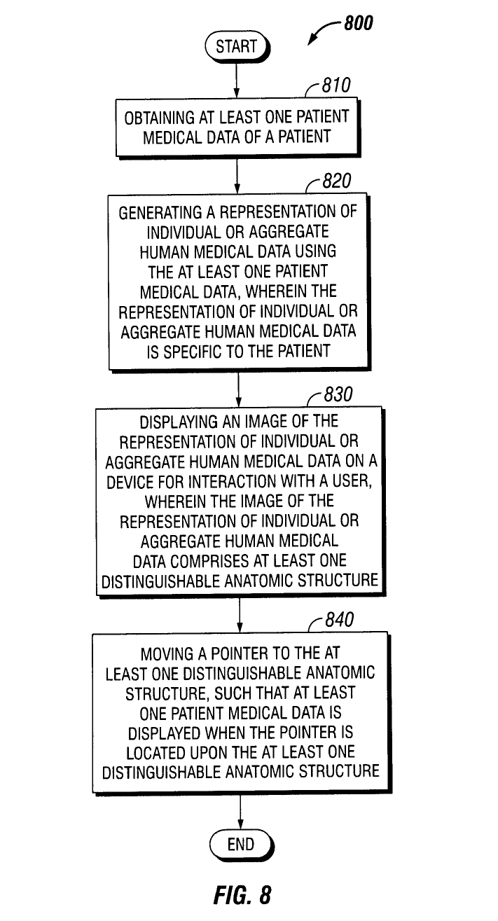

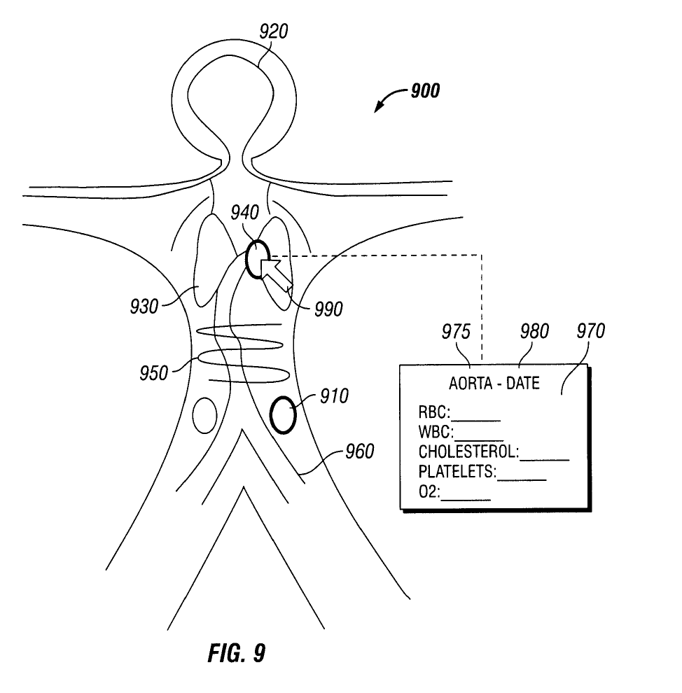

FIG. 8 illustrates a flowchart of a method 800 for generating and displaying a representation of individual or aggregate human medical data, wherein a pointer is used to display at least one patient medical data for an exemplary embodiment. The method illustrated in steps 810 and 820 in FIG. 8 is identical to the method described above in steps 510 and 520 of FIG. 5. Additionally, at step 830, the image of the representation of individual or aggregate human medical data is displayed on a device for interaction with a user, wherein the image of the representation of individual or aggregate human medical data comprises at least one distinguishable anatomical structure. FIG. 9 illustrates a perspective view of a representation of individual or aggregate human medical data 900 having at least one distinguishable anatomical structure 940 with a pointer 990 located on top of the distinguishable anatomical structure 940 for an exemplary embodiment. As illustrated in FIG. 9, there are many distinguishable anatomical structures, including the aorta 940, the brain 920, the lymphatic system 960, the kidneys 910, the lungs 930, and the intestines 950. FIG. 9 shows the pointer 990 located on top of the aorta 940 and displaying at least one patient medical data that is associated with the aorta 940.

Referring back to FIG. 8, at step 840, the pointer is moved to at least one distinguishable anatomical structure, such that at least one patient medical data is displayed when the pointer is located upon the at least one distinguishable anatomical structure. FIG. 9 shows the pointer 990 moved onto the aorta 940, wherein the associated current patient medical data 970 is displayed on the display along with the anatomical structure identifier 975 and the date 980 the current medical data 970 is associated with. The patient medical data associated with the aorta is shown to comprise red blood cell count, white blood cell count, cholesterol, platelet count and oxygen level. Although FIG. 9 shows that the red blood cell count, the white blood cell count, the cholesterol, the platelet count and the oxygen level are associated with the aorta, there may be alternative associated patient medical data without departing from the scope and spirit of the exemplary embodiment. In this manner, the method 800 provides a context-sensitive graphical user interface for use by medical professionals throughout the medical treatment of a patient.

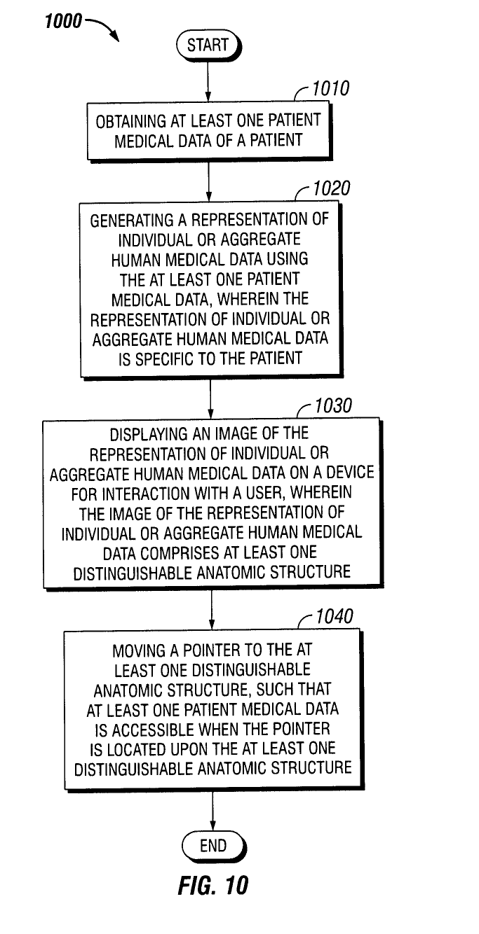

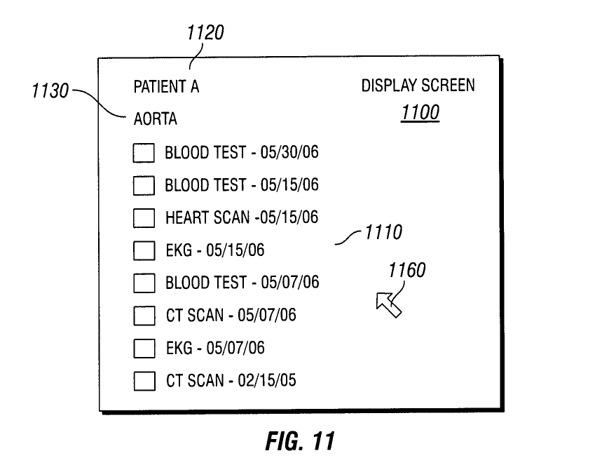

FIG. 10 illustrates a flowchart of a method 1000 for generating and displaying a representation of individual or aggregate human medical data, wherein a pointer is used to access at least one patient medical data for an exemplary embodiment. The method illustrated in steps 1010, 1020 and 1030 in FIG. 10 are identical to the method described above in steps 810, 820 and 830 of FIG. 8. At step 1040, a pointer is moved to at least one distinguishable anatomical structure, such that at least one patient medical data is accessible when the pointer is located upon the at least one distinguishable anatomical structure. FIG. 9 shows the pointer 990 moved onto the aorta 940, wherein the associated current patient medical data 970 is displayed on the display. The patient medical data 970 associated with the aorta 940 is shown to comprise red blood cell count, white blood cell count, cholesterol, platelet count and oxygen level. When the pointer 990 is clicked on the aorta 940, a display screen 1100 as shown in FIG. 11 appears. FIG. 11 illustrates a pictorial view of the display screen 1100 showing accessible patient medical data 1110 for an exemplary embodiment. This screen illustrates all the accessible patient medical data 1110 that has been associated with the aorta 940 (FIG. 9), comprising blood tests, heart scans, EKGs and CT scans. Although FIG. 11 shows that the blood tests, heart scans, EKGs and CT scans are patient medical data 1110 associated with the aorta, there may be alternative associated patient medical data 1110 without departing from the scope and spirit of the exemplary embodiment. The medical provider may use the pointer 1160 to click on the desired associated patient medical data 1110 to view the detailed results. This associated patient medical data 1110 may be sorted by the type of patient medical data 1110 or by the date. Additionally, FIG. 11 displays the patient identifier 1120 and the selected anatomical structure 1130 on the display screen 1100.

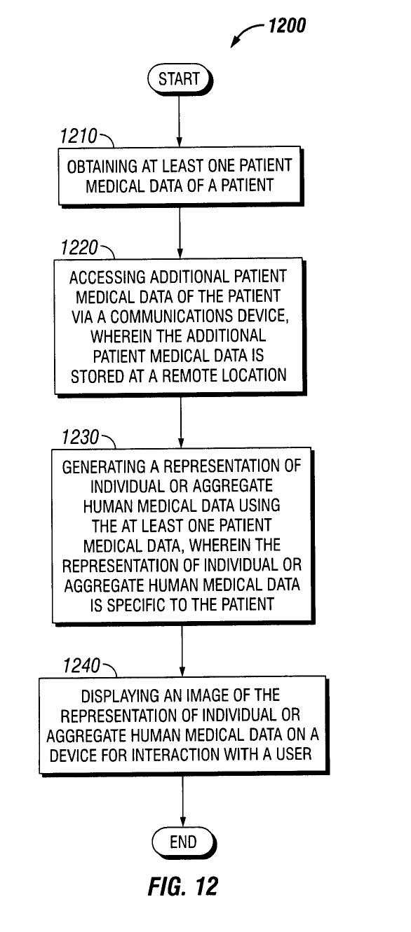

FIG. 12 illustrates a flowchart of a method 1200 for generating and displaying a representation of individual or aggregate human medical data, wherein additional patient medical data stored at a remote location is accessed via a communications device for an exemplary embodiment The method illustrated in steps 1210, 1230 and 1240 in FIG. 12 is identical to the method described above in steps 510, 520 and 530 of FIG. 5. Additionally, at step 1220, additional patient medical data of the at least one patient is accessed via a communications device, wherein the additional patient medical data is stored at a remote location. As described in FIG. 1 above, additional patient medical data may be accessed from the plurality of remote local networks 115 and/or the centralized server 130 having the at least one centralized patient medical database 135.

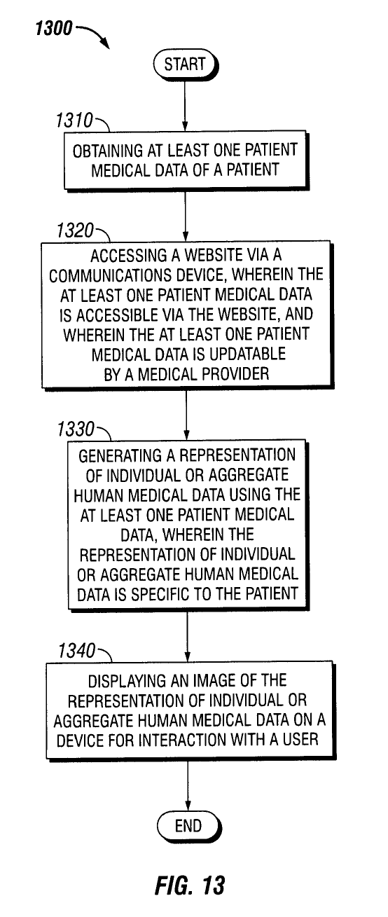

FIG. 13 illustrates a flowchart of a method 1300 for generating and displaying a representation of individual or aggregate human medical data, wherein additional patient medical data is accessible from a website via a communications device and the medical provider may upload additional patient medical data for an exemplary embodiment. The method illustrated in steps 1310, 1330 and 1340 in FIG. 13 is identical to the method described above in steps 510, 520 and 530 of FIG. 5.

Additionally, at step 1320, a website may be accessed via a communications device, wherein the at least one patient medical data is accessible via the website, and wherein the at least one patient medical data is updatable by a medical provider.

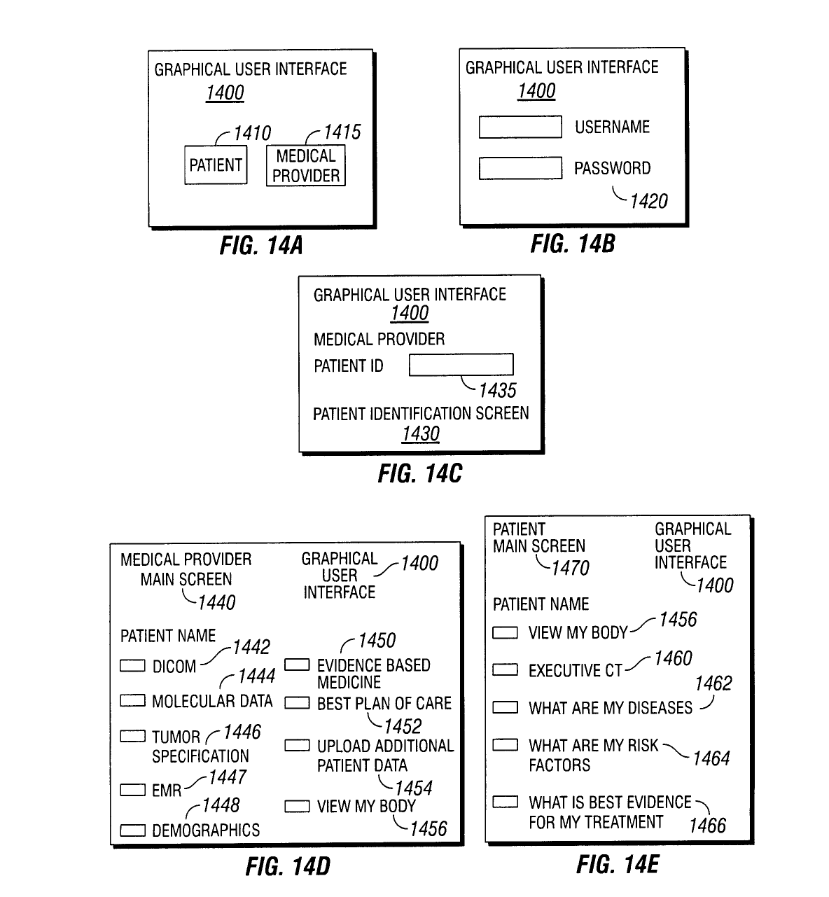

FIGS. 14A-E illustrates one or more screenshots of a graphical user interface for an exemplary embodiment. This graphical user interface 1400 may reside and be executed on either the local computer or on the website. FIG. 14A illustrates one screenshot wherein the user selects either a patient portal 1410 or a medical provider portal 1415. Once the user selects the desired portal, the screenshot shown in FIG. 14B appears so that the user may input user identification information 1420. This user identification information 1420 may be in the form of a user name and password, social security number, patient identification number or any other identifying information. If the medical provider portal 1415 was selected in the screenshot shown in FIG. 14A, the next screenshot appearing after FIG. 14B may be a patient identification screen 1430 wherein the medical provider inputs information for selecting a particular patient. This input may take the form of a patient ID number 1435. FIG. 14D illustrates the medical provider main screen 1440 of the medical provider portal 1415. This screenshot comprises a plurality of links comprising Dicom 1442, Molecular data 1444, tumor specifications 1446, EMR 1447, Demographics 1448, evidence based medicine 1450, best plan of care 1452, upload additional patient medical data 1454 and view my body 1456. FIG. 14E illustrates a patient main screen 1470 of the patient portal. This screenshot comprises at least one link comprising view my body 1456, executive CT 1460, what are my diseases 1462, what are my risk factors 1464, and what is best evidence for my treatment 1466.

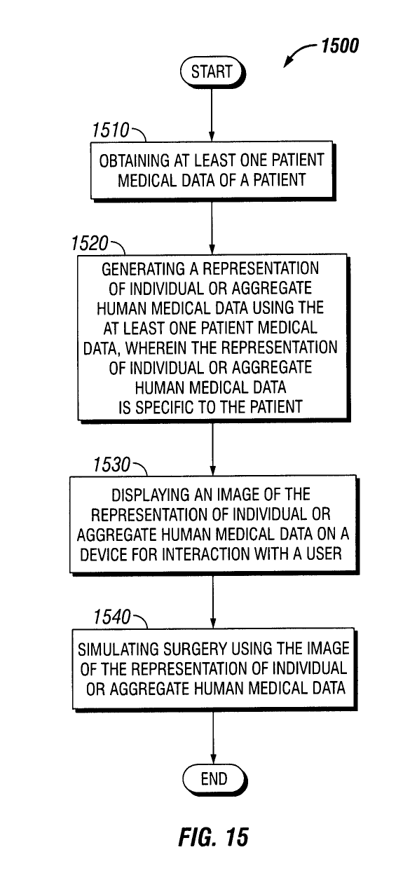

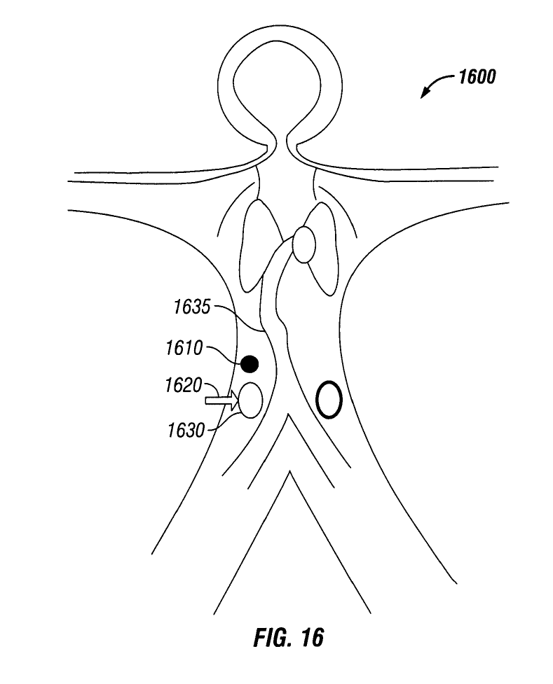

FIG. 15 illustrates a flowchart of a method 1500 for generating and displaying a representation of individual or aggregate human medical data, wherein the image of the representation of individual or aggregate human medical data may be used for simulating surgery for an exemplary embodiment. The method illustrated in steps 1510, 1520 and 1530 in FIG. 15 is identical to the method described above in steps 510, 520 and 530 of FIG. 5. Additionally, at step 1540, surgery is simulated using the image of the representation of individual or aggregate human medical data. FIG. 16 illustrates a perspective view of a representation of individual or aggregate human medical data 1600 showing a surgical tool 1620 and a positioning locator device 1610 comprising a scope 1615 for an exemplary embodiment. The positioning locator device 1610 may be a GPS locator in an exemplary embodiment. Although the positioning locator device 1610 may be a GPS device, any other positioning locator device may be used without departing from the scope and spirit of the exemplary embodiment. The scope 1615 may assist in gathering patient medical data for generating the representation of individual or aggregate human medical data 1600. The positioning locator device 1610 provides a reference point and the scope 1615 provides a visual for determining the position of the surgical tool 1620 with reference to the surrounding anatomical structures 1630, 1635, thereby successfully facilitating the simulated surgery. Since the image of the representation of individual or aggregate human medical data 1600 is an approximate representation of the anatomical structures within the actual patient, surgery may first be simulated on the representation of individual or aggregate human medical data 1600 before performing surgery on the actual patient. By being able to simulate the surgery, medical providers will be able to learn of possible complications and thus anticipate them before performing actual surgery. Surgery simulations may also be performed as a training exercise.

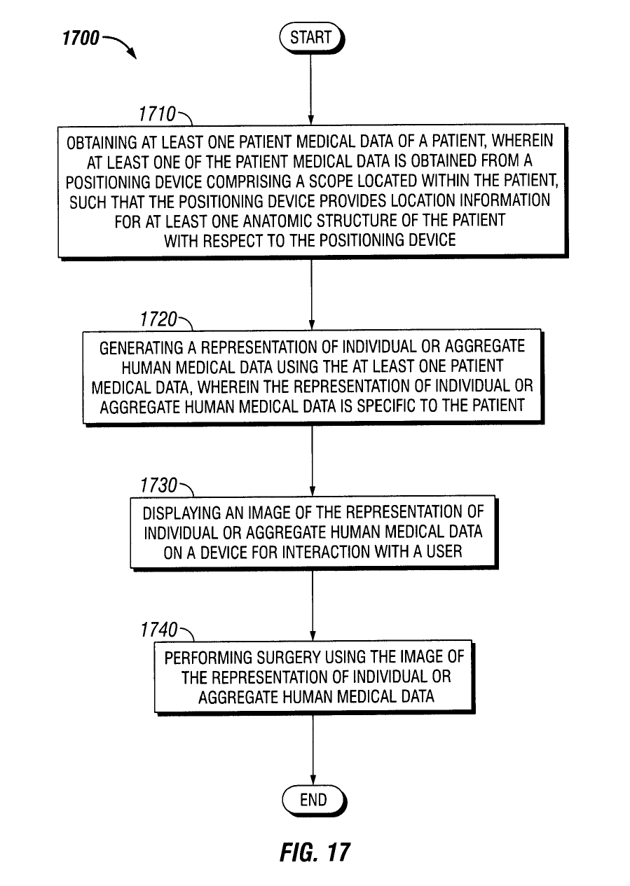

FIG. 17 illustrates a flowchart of a method 1700 for generating and displaying a representation of individual or aggregate human medical data, wherein the image of the representation of individual or aggregate human medical data may be used for performing surgery for an exemplary embodiment. The method illustrated in steps 1720 and 1730 in FIG. 17 is identical to the method described above in steps 520 and 530 of FIG. 5. Additionally, at step 1710, at least one patient medical data of a patient is obtained, wherein at least one patient medical data is obtained from a positioning locator device comprising a scope located within the patient, such that the positioning device provides location information for at least one anatomical structure of the patient with respect to the positioning device. As discussed in FIG. 16, FIG. 16 illustrates a perspective view of a representation of individual or aggregate human medical data 1600 showing a surgical tool 1620 and a positioning locator device 1610 comprising a scope 1615 for an exemplary embodiment. The positioning locator device 1610 may be a GPS locator in an exemplary embodiment. Although the positioning locator device 1610 may be a GPS device, any other positioning locator device may be used without departing from the scope and spirit of the exemplary embodiment. The scope 1615 may assist in gathering patient medical data for generating the representation of individual or aggregate human medical data 1600. The positioning locator device 1610 provides a reference point and the scope 1615 provides a visual for determining the position of the surgical tool 1620 with reference to the surrounding anatomical structures 1630, 1635, thereby successfully facilitating the surgery. During surgery, the medical provider may use and manipulate the representation to assist in making decisions.

At step 1740, surgery is performed using the image of the representation of individual or aggregate human medical data. Since the image of the representation of individual or aggregate human medical data is an approximate representation of the anatomical structures within the actual patient, surgery may be performed, with assistance from the GPS device with scope located in the patient and shown within the representation of individual or aggregate human medical data. The surgical tool may penetrate the patient during surgery, and the medical provider will be able to see a visual of all the anatomical structures that are in proximity to the surgical tool. The medical provider may be able to view the surgical tool as it moves in close proximity to the anatomical structures. Thus, the medical provider may reduce the risk of surgery complications by reducing the chances of the surgical tool penetrating any of the anatomical structures.

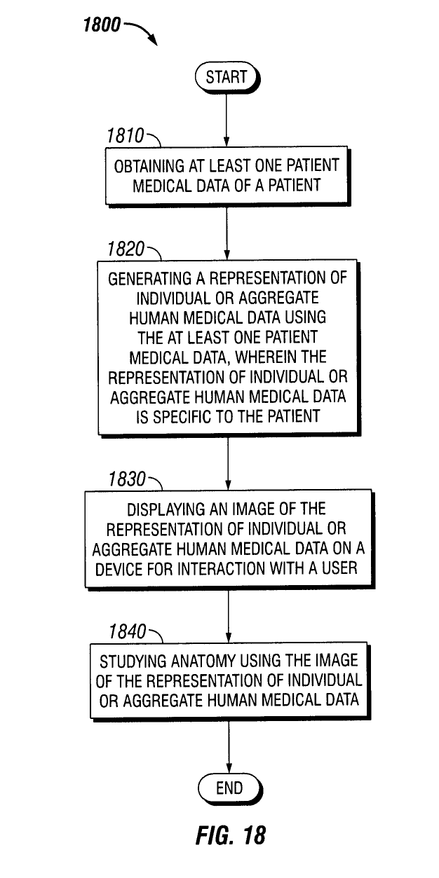

FIG. 18 illustrates a flowchart of a method 1800 for generating and displaying a representation of individual or aggregate human medical data, wherein the image of the representation of individual or aggregate human medical data may be used for studying anatomy for an exemplary embodiment. The method illustrated in steps 1810, 1820 and 1830 in FIG. 18 is identical to the method described above in steps 510, 520 and 530 of FIG. 5. Additionally, at step 1840, the anatomy of a human body may be studied using the image of the representation of individual or aggregate human medical data. Since the image of the representation of individual or aggregate human medical data is an approximate representation of the anatomical structures within the actual patient, students may learn anatomy from the representation of individual or aggregate human medical data, in lieu of only textbooks and/or cadavers.

FIGS. 15, 17 and 18 all describe exemplary methods of manipulating the representation of individual or aggregate human medical data for decision making medical purposes. FIG. 15 manipulates the representation for the medical purpose of simulating surgery. FIG. 17 manipulates the representation for the medical purpose of performing surgery. FIG. 18 manipulates the representation for the medical purpose of studying anatomy. However, the representation of individual or aggregate human medical data may be also be manipulated for other medical purposes, such as, but not limited to, treatment and prevention planning, patient education, and research. The medical provider may make decisions based upon the manipulation of the representation.

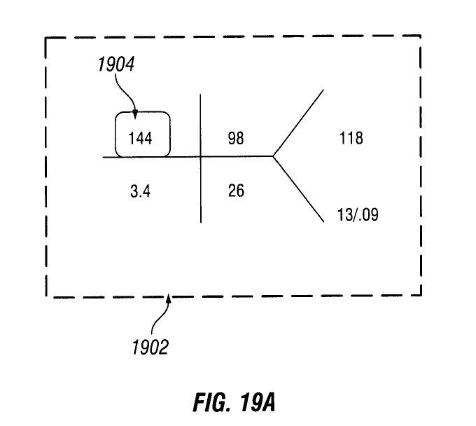

Referring now to FIG. 19a, in an exemplary embodiment, a GUI 1900 includes an illustration of medical information 1902 for a patient that includes a current numerical value 1904 for a particular medical parameter.

Referring now to FIG. 19b, in an exemplary embodiment, when a mouse pointer icon 1906 is passed over the value 1904, the value is highlighted by a color coded overlay 1908, and a GUI 1910 appears proximate the GUI 1900 that includes:

a graphical bar illustration 1912 of the upper and lower limits of normal values for the particular medical parameter, a textual illustration 1914 of the lower limit of the normal value for the particular medical parameter positioned proximate a lower end of the graphical illustration 1912, a textual illustration 1916 of the upper limit of the normal value for the particular medical parameter proximate an upper end of the graphical illustration 1912, the current numerical value 1918 for the particular medical parameter overlayed onto a color coded shape 1920, and one or more historical values, 1922, 1924, 1926, 1928, and 1930, overlayed onto corresponding color coded shapes, 1932, 1934, 1936, 1938, and 1940, respectively.

In an exemplary embodiment, the vertical position of the values, 1918, 1920, 1922, 1924, 1926, 1928, and 1930, are representative of their relative values. In an exemplary embodiment, the geometry of the shapes, 1920, 1932, 1934, 1936, 1938, and 1940, are representative of the degree to which their value may have been affected by a medical treatment. For example, the shapes, 1934 and 1938, are elongated relative to the other shapes, 1920, 1932, 1936, and 1940, to indicate that the corresponding values, 1924 and 1928, may have been affected by corresponding medical treatments. In an exemplary embodiment, the corresponding medical treatments are indicated by corresponding textual messages, 1942 and 1944.

In an exemplary embodiment, the GUI 1902 is connected to the GUI 1910 by a leader line 1946 to indicate that these GUIs are related to one another. In an exemplary embodiment, the elongated shapes, 1934 and 1938, are connected to the corresponding textual messages, 1942 and 1944, by corresponding leader lines, 1948 and 1950, to indicate that these GUI elements are related to one another.

In an exemplary embodiment, the particular medical parameter represented by the value 1904 is serum sodium.

Thus, the GUIs, 1902 and 1910, illustrated in FIGS. 19a and 19b provide a dynamic GUI system that provides a medical professional with an interactive graphical user interface that permits more effective treatment of a patient.

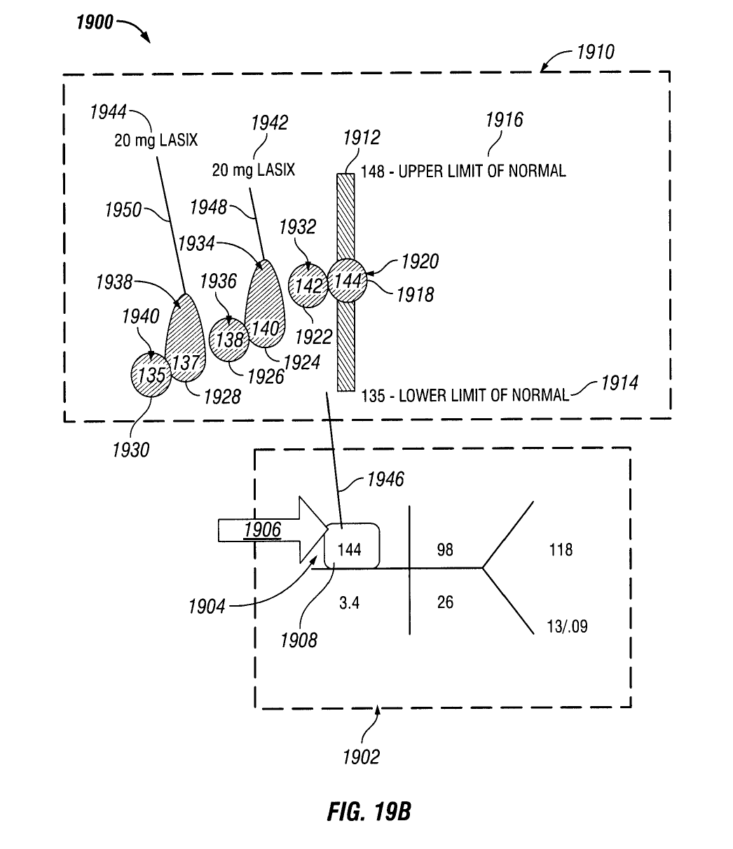

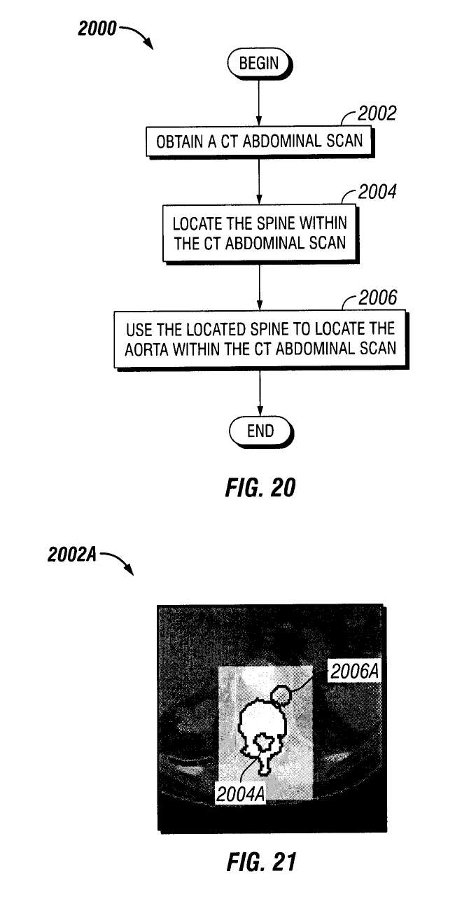

Referring now to FIGS. 20 and 21, an exemplary embodiment of a method 2000 for automatic labeling of the aorta in CT abdominal images is provided in which, in 2002, a CT abdominal scan 2002a is obtained.

In 2004, the spine 2004a is located within the scan 2002a in a conventional manner.

In 2006, the location of the spine 2004a is then used to determine the location of the aorta 2006a within the scan 2002a in a conventional manner.

In an exemplary embodiment, the teachings of the method 2000 may be extended to identification of any anatomical structure within a CT scan, or other body image, in which the spine is used as an anchor object for identifying and labeling other anatomical structures.

A computer system has been described that includes a processor; a database that stores a plurality of patient medical data of at least one patient; a virtual patient module that comprises instructions to build a virtual patient that is specific to the at least one patient; and a device to display an image of the virtual patient to a user based upon the plurality of patient medical data. In an exemplary embodiment, the virtual patient is three-dimensional. In an exemplary embodiment, the plurality of patient medical data of the at least one patient comprises a full body CT scan, and the full body CT scan comprises a plurality of anatomic structures. In an exemplary embodiment, the computer system further includes an anatomical structure detection engine that comprises instructions to recognize at least a portion of the plurality of anatomic structures illustrated in the full body CT scan. In an exemplary embodiment, the instructions recognize at least a portion of the plurality of anatomic structures using density units. In an exemplary embodiment, the density units are Houndsfield units. In an exemplary embodiment, instructions recognize at least a portion of the plurality of anatomic structures using a grid system. In an exemplary embodiment, the instructions to recognize at least a portion of the plurality of anatomic structures comprise instructions for first identifying the location of the spine and then using the identified location of the spine as a reference point for indentifying other anatomic structures. In an exemplary embodiment, the plurality of patient medical data of the at least one patient comprises information from at least one diagnostic test. In an exemplary embodiment, the information comprises at least one image data, the at least one image data comprises a plurality of anatomic structures. In an exemplary embodiment, the computer system further includes an anatomical structure detection engine that comprises instructions to recognize at least a portion of the plurality of anatomic structures illustrated in the at least one image data. In an exemplary embodiment, the instructions to recognize at least a portion of the plurality of anatomic structures is performed via density units. In an exemplary embodiment, the density units are Houndsfield units. In an exemplary embodiment, the instructions to recognize at least a portion of the plurality of anatomic structures is performed via a grid system. In an exemplary embodiment, the instructions to recognize at least a portion of the plurality of anatomic structures comprise instructions for first identifying the location of the spine and then using the identified location of the spine as a reference point for indentifying other anatomic structures. In an exemplary embodiment, the database stores a plurality of patient medical data obtained at various time periods, and wherein the plurality of patient medical data is sortable by the various time periods. In an exemplary embodiment, the image of the virtual patient comprises at least one distinguishable anatomic structure. In an exemplary embodiment, the at least one distinguishable anatomic structure is highlightable. In an exemplary embodiment, the computer system further includes a patient medical data association engine that comprises instructions to associate a portion of the plurality of patient medical data with the at least one distinguishable anatomic structure. In an exemplary embodiment, the computer system 19, further includes an abnormal patient medical data identification engine that comprises instructions to highlight the at least one distinguishable anatomic structure, wherein at least one associated portion of the plurality of patient medical data falls outside a desired range. In an exemplary embodiment, the desired range is about two standard deviations from a population average. In an exemplary embodiment, the computer system further includes a pointer, wherein the pointer is movable to the at least one distinguishable anatomic structure, such that a portion of the plurality of patient medical data is displayed when the pointer is located upon the at least one distinguishable anatomic structure. In an exemplary embodiment, the plurality of patient medical data that is displayed when the pointer is located upon the at least one distinguishable anatomic structure comprises current and historical medical data. In an exemplary embodiment, the plurality of patient medical data that is displayed when the pointer is located upon the at least one distinguishable anatomic structure comprises one or more medical treatments associated with one or more of the medical data. In an exemplary embodiment, the pointer is further movable to the plurality of patient medical data that is displayed when the pointer is located upon the at least one distinguishable anatomic structure, such that further related patient medical data is displayed when the pointer is located upon the plurality of patient medical data. In an exemplary embodiment, the further related patient medical data comprises current and historical medical data. In an exemplary embodiment, the further related patient medical data comprises one or more medical treatments associated with one or more of the further related medical data. In an exemplary embodiment, the computer system further includes a patient medical data association engine that comprises instructions to associate the portion of the plurality of patient medical data with the at least one distinguishable anatomic structure. In an exemplary embodiment, the portion of the plurality of patient medical data comprises information related to a blood test. In an exemplary embodiment, the portion of the plurality of patient medical data is current information. In an exemplary embodiment, the computer system further includes a pointer, wherein the pointer is movable to the at least one distinguishable anatomic structure, such that a portion of the plurality of patient medical data is accessible when the pointer is located upon the at least one distinguishable anatomic structure. In an exemplary embodiment, the computer system further includes a patient medical data association engine that comprises instructions to associate the portion of the plurality of patient medical data with the at least one distinguishable anatomic structure. In an exemplary embodiment, the portion of the plurality of patient medical data comprises information from at least one diagnostic test, wherein the at least one diagnostic test is selected from a group consisting of a blood test, an x-ray, a CT scan, a PET scan and a blood test. In an exemplary embodiment, the portion of the plurality of patient medical data comprises current information. In an exemplary embodiment, the portion of the plurality of patient medical data comprises historical information. In an exemplary embodiment, the plurality of patient medical data comprises heredity traits of parents and siblings and diseases of parents and siblings. In an exemplary embodiment, the computer system further includes a best plan of care engine that comprises instructions to provide diagnostic information. In an exemplary embodiment, the computer system further includes a recommended diagnostic test reminder engine that comprises instructions to provide reminders of recommended diagnostic tests based upon the plurality of patient medical data. In an exemplary embodiment, the computer system further includes a communications device for accessing additional patient medical data of the at least one patient, wherein the additional patient medical data is stored at a remote location. In an exemplary embodiment, the computer system further includes a GUI having access to a medical provider portal. In an exemplary embodiment, the medical provider portal comprises a plurality of links, wherein at least one of the plurality of links is selected from a group consisting of a dicom, a molecular data, a tumor specification, an EMR, a demographics, an evidenced based medicine and a best plan of care. In an exemplary embodiment, the best plan of care is determined via a best plan of care engine. In an exemplary embodiment, the GUI has access to a patient portal. In an exemplary embodiment, the patient portal comprises a plurality of links, wherein at least one of the plurality of links is selected from a group consisting of a view my body, an executive CT, a what are my diseases, a what are my risk factors, and a what is best evidence for my treatment. In an exemplary embodiment, the computer system further includes a communications device for accessing a website, wherein the database is accessible via the website, and wherein the database is updatable by a medical provider. In an exemplary embodiment, a plurality of engines are executed from the website.

A computer implemented method has been described that includes obtaining a plurality of patient medical data of a patient; generating a virtual patient using the plurality of patient medical data, wherein the virtual patient is specific to the patient; and displaying an image of the virtual patient on a device for interaction with a user. In an exemplary embodiment, the virtual patient is three-dimensional. In an exemplary embodiment, the plurality of patient medical data comprises a full body CT scan, and the full body CT scan comprises a plurality of anatomic structures. In an exemplary embodiment, generating a virtual patient using the plurality of patient medical data comprises recognizing at least a portion of the plurality of anatomic structures illustrated in the full body CT scan. In an exemplary embodiment, recognizing at least a portion of the plurality of anatomic structures comprises using density units. In an exemplary embodiment, the density units are Houndsfield units. In an exemplary embodiment, recognizing at least a portion of the plurality of anatomic structures comprises using a grid system. In an exemplary embodiment, recognizing at least a portion of the plurality of anatomic structures comprises first identifying the location of the spine and then using the identified location of the spine as a reference point for indentifying other anatomic structures. In an exemplary embodiment, the plurality of patient medical data comprises information from at least one diagnostic test. In an exemplary embodiment, the information comprises at least one image data, the at least one image data comprises a plurality of anatomic structures. In an exemplary embodiment, generating a virtual patient using the plurality of patient medical data comprises recognizing at least a portion of the plurality of anatomic structures illustrated in the at least one image data. In an exemplary embodiment, recognizing at least a portion of the plurality of anatomic structures comprises using density units. In an exemplary embodiment, the density units are Houndsfield units. In an exemplary embodiment, recognizing at least a portion of the plurality of anatomic structures comprises using a grid system. In an exemplary embodiment, recognizing at least a portion of the plurality of anatomic structures comprises first identifying the location of the spine and then using the identified location of the spine as a reference point for indentifying other anatomic structures. In an exemplary embodiment, the plurality of patient medical data is stored in a database. In an exemplary embodiment, the plurality of patient medical data is obtained at various time periods, and wherein the plurality of patient medical data is sortable by the various time periods. In an exemplary embodiment, the image of the virtual patient comprises at least one distinguishable anatomic structure. In an exemplary embodiment, the at least one distinguishable anatomic structure is highlightable. In an exemplary embodiment, generating a virtual patient using the plurality of patient medical data comprises associating a portion of the plurality of patient medical data with the at least one distinguishable anatomic structure. In an exemplary embodiment, generating a virtual patient using the plurality of patient medical data comprises instructions to highlight the at least one distinguishable anatomic structure, wherein at least one associated portion of the plurality of patient medical data falls outside a desired range. In an exemplary embodiment, the desired range is about two standard deviations from a population average. In an exemplary embodiment, the method further includes moving a pointer to the at least one distinguishable anatomic structure, such that a portion of the plurality of patient medical data is displayed when the pointer is located upon the at least one distinguishable anatomic structure. In an exemplary embodiment, the plurality of patient medical data that is displayed when the pointer is located upon the at least one distinguishable anatomic structure comprises current and historical medical data. In an exemplary embodiment, the plurality of patient medical data that is displayed when the pointer is located upon the at least one distinguishable anatomic structure comprises one or more medical treatments associated with one or more of the medical data. In an exemplary embodiment, the pointer is further movable to the plurality of patient medical data that is displayed when the pointer is located upon the at least one distinguishable anatomic structure, such that further related patient medical data is displayed when the pointer is located upon the plurality of patient medical data. In an exemplary embodiment, the further related patient medical data comprises current and historical medical data. In an exemplary embodiment, the further related patient medical data comprises one or more medical treatments associated with one or more of the further related medical data. In an exemplary embodiment, generating a virtual patient using the plurality of patient medical data comprises associating the plurality of patient medical data with the at least one distinguishable anatomic structure. In an exemplary embodiment, the portion of the plurality of patient medical data comprises information related to a blood test. In an exemplary embodiment, the portion of the plurality of patient medical data is current information. In an exemplary embodiment, the portion of the plurality of patient medical data is historical information. In an exemplary embodiment, the plurality of patient medical data comprises heredity traits of parents and siblings and diseases of parents and siblings. In an exemplary embodiment, generating a virtual patient using the plurality of patient medical data comprises providing diagnostic information. In an exemplary embodiment, generating a virtual patient using the plurality of patient medical data comprises providing reminders of recommended diagnostic tests based upon the plurality of patient medical data. In an exemplary embodiment, the method further includes accessing additional patient medical data of the at least one patient via a communications device, wherein the additional patient medical data is stored at a remote location. In an exemplary embodiment, wherein displaying an image of the virtual patient on a device for interaction with a user comprises a GUI having access to a medical provider portal. In an exemplary embodiment, the medical provider portal comprises a plurality of links, wherein at least one of the plurality of links is selected from a group consisting of a dicom, a molecular data, a tumor specification, an EMR, a demographics, an evidenced based medicine and a best plan of care. In an exemplary embodiment, the best plan of care is determined via a best plan of care engine. In an exemplary embodiment, the GUI has access to a patient portal. In an exemplary embodiment, the patient portal comprises a plurality of links, wherein at least one of the plurality of links is selected from a group consisting of a view my body, an executive CT, a what are my diseases, a what are my risk factors, and a what is best evidence for my treatment. In an exemplary embodiment, the method further includes accessing a website via a communications device, wherein the plurality of patient medical data is accessible via the website, and wherein the plurality of patient medical data is updatable by a medical provider. In an exemplary embodiment, a plurality of engines are executed from the website. In an exemplary embodiment, the method further includes simulating surgery using the image of the virtual patient. In an exemplary embodiment, a portion of the plurality of patient medical data is obtained from a positioning device comprising a scope located within the patient, such that the positioning device provides location information for a plurality of anatomic structures of the patient with respect to the positioning device. In an exemplary embodiment, the method further includes performing surgery using the image of the virtual patient. In an exemplary embodiment, the positioning device is a GPS device. In an exemplary embodiment, the method further includes studying anatomy using the image of the virtual patient.

A computer database stored in a memory device has been described that includes a plurality of patient medical data of at least one patient, wherein the plurality of patient medical data is used to build a virtual patient that is specific to the patient. In an exemplary embodiment, the plurality of patient medical data comprises an image, wherein the image comprises a plurality of anatomic structures. In an exemplary embodiment, at least a portion of the plurality of anatomic structures are identifiable via density units. In an exemplary embodiment, the database further includes a detailed anatomic data set. In an exemplary embodiment, at least a portion of the plurality of anatomic structures are identifiable via a grid system, wherein the grid system compares the portion of the plurality of anatomic structures to the detailed anatomic data set. In an exemplary embodiment, the plurality of patient medical data is sortable via the plurality of anatomic structures. In an exemplary embodiment, the plurality of patient medical data is sortable via an acquired date. In an exemplary embodiment, the plurality of patient medical data is sortable via a diagnostic scan type. In an exemplary embodiment, the plurality of patient medical data comprises a recommended population data set. In an exemplary embodiment, the plurality of patient medical data comprises heredity traits and diseases of the parents and the siblings of the at least one patient. In an exemplary embodiment, the database is accessible via a network. In an exemplary embodiment, additional patient medical data is updatable by a medical provider having access to the network. In an exemplary embodiment, the database is accessible via a website. In an exemplary embodiment, additional patient medical data is updatable by a medical provider having access to the website.

A computer program has been described that includes instructions for obtaining a plurality of patient medical data of a patient; generating a virtual patient using the plurality of patient medical data, wherein the virtual patient is specific to the patient; and displaying an image of the virtual patient on a device for interaction with a user. In an exemplary embodiment, the virtual patient is three-dimensional. In an exemplary embodiment, the plurality of patient medical data comprises a full body CT scan, wherein the full body CT scan comprises a plurality of anatomic structures. In an exemplary embodiment, generating a virtual patient using the plurality of patient medical data comprises recognizing at least a portion of the plurality of anatomic structures illustrated in the full body CT scan. In an exemplary embodiment, recognizing at least a portion of the plurality of anatomic structures comprises using density units. In an exemplary embodiment, the density units are Houndsfield units. In an exemplary embodiment, recognizing at least a portion of the plurality of anatomic structures comprises using a grid system. In an exemplary embodiment, recognizing at least a portion of the plurality of anatomic structures comprises first identifying the location of the spine and then using the identified location of the spine as a reference point for indentifying other anatomic structures. In an exemplary embodiment, the plurality of patient medical data comprises information from at least one diagnostic test. In an exemplary embodiment, the information comprises at least one image data, the at least one image data comprises a plurality of anatomic structures. In an exemplary embodiment, generating a virtual patient using the plurality of patient medical data comprises recognizing at least a portion of the plurality of anatomic structures illustrated in the at least one image data. In an exemplary embodiment, recognizing at least a portion of the plurality of anatomic structures comprises using density units. In an exemplary embodiment, the density units are Houndsfield units. In an exemplary embodiment, recognizing at least a portion of the plurality of anatomic structures comprises using a grid system. In an exemplary embodiment, recognizing at least a portion of the plurality of anatomic structures comprises first identifying the location of the spine and then using the identified location of the spine as a reference point for indentifying other anatomic structures. In an exemplary embodiment, the plurality of patient medical data is stored in a database. In an exemplary embodiment, the plurality of patient medical data is obtained at various time periods, and wherein the plurality of patient medical data is sortable by the various time periods. In an exemplary embodiment, the image of the virtual patient comprises at least one distinguishable anatomic structure. In an exemplary embodiment, the at least one distinguishable anatomic structure is highlightable. In an exemplary embodiment, generating a virtual patient using the plurality of patient medical data comprises associating a portion of the plurality of patient medical data with the at least one distinguishable anatomic structure. In an exemplary embodiment, generating a virtual patient using the plurality of patient medical data comprises instructions to highlight the at least one distinguishable anatomic structure, wherein at least one associated portion of the plurality of patient medical data falls outside a desired range. In an exemplary embodiment, the desired range is about two standard deviations from a population average. In an exemplary embodiment, the computer program further includes instructions for moving a pointer to the at least one distinguishable anatomic structure, such that a portion of the plurality of patient medical data is displayed when the pointer is located upon the at least one distinguishable anatomic structure. In an exemplary embodiment, the plurality of patient medical data that is displayed when the pointer is located upon the at least one distinguishable anatomic structure comprises current and historical medical data. In an exemplary embodiment, the plurality of patient medical data that is displayed when the pointer is located upon the at least one distinguishable anatomic structure comprises one or more medical treatments associated with one or more of the medical data. In an exemplary embodiment, the pointer is further movable to the plurality of patient medical data that is displayed when the pointer is located upon the at least one distinguishable anatomic structure, such that further related patient medical data is displayed when the pointer is located upon the plurality of patient medical data. In an exemplary embodiment, the further related patient medical data comprises current and historical medical data. In an exemplary embodiment, the further related patient medical data comprises one or more medical treatments associated with one or more of the further related medical data. In an exemplary embodiment, generating a virtual patient using the plurality of patient medical data comprises associating the plurality of patient medical data with the at least one distinguishable anatomic structure. In an exemplary embodiment, the portion of the plurality of patient medical data comprises information related to a blood test. In an exemplary embodiment, the portion of the plurality of patient medical data is current information. In an exemplary embodiment, the portion of the plurality of patient medical data is historical information. In an exemplary embodiment, the plurality of patient medical data comprises heredity traits of parents and siblings and diseases of parents and siblings. In an exemplary embodiment, generating a virtual patient using the plurality of patient medical data comprises providing diagnostic information. In an exemplary embodiment, generating a virtual patient using the plurality of patient medical data comprises providing reminders of recommended diagnostic tests based upon the plurality of patient medical data. In an exemplary embodiment, the computer program further includes instructions for accessing additional patient medical data of the at least one patient via a communications device, wherein the additional patient medical data is stored at a remote location. In an exemplary embodiment, displaying an image of the virtual patient on a device for interaction with a user comprises a GUI having access to a medical provider portal. In an exemplary embodiment, the medical provider portal comprises a plurality of links, wherein at least one of the plurality of links is selected from a group consisting of a dicom, a molecular data, a tumor specification, an EMR, a demographics, an evidenced based medicine and a best plan of care. In an exemplary embodiment, the best plan of care is determined via a best plan of care engine. In an exemplary embodiment, the GUI has access to a patient portal. In an exemplary embodiment, the patient portal comprises a plurality of links, wherein at least one of the plurality of links is selected from a group consisting of a view my body, an executive CT, a what are my diseases, a what are my risk factors, and a what is best evidence for my treatment. In an exemplary embodiment, the computer program further includes instructions for accessing a website via a communications device, wherein the plurality of patient medical data is accessible via the website, and wherein the plurality of patient medical data is updatable by a medical provider. In an exemplary embodiment, the plurality of engines are executed from the website. In an exemplary embodiment, the computer program further includes instructions for simulating surgery using the image of the virtual patient. In an exemplary embodiment, a portion of the plurality of patient medical data is obtained from a positioning device comprising a scope located within the patient, such that the positioning device provides location information for a plurality of anatomic structures of the patient with respect to the positioning device. In an exemplary embodiment, the computer program further includes instructions for performing surgery using the image of the virtual patient. In an exemplary embodiment, the positioning device is a GPS device. In an exemplary embodiment, the computer program further includes instructions for studying anatomy using the image of the virtual patient.

A graphical user interface has been described that includes at least one portal, the portal being associated with a database containing a plurality of patient medical data; a window region to display results; and a menu selection region containing selectable categories, wherein results are associated with each of the selectable categories. In an exemplary embodiment, the portal is a medical provider portal and wherein the selectable categories are selected from a group consisting of dicom, molecular data, tumor specifications, EMR, demographics, evidenced based medicine and best plan of care. In an exemplary embodiment, the medical provider portal requires a security pass code, wherein the security pass code determines the level of access. In an exemplary embodiment, the portal is a patient portal and wherein the selectable categories are selected from a group consisting of view my body, executive CT, what are my diseases, what are my risk factors and what is the best evidence for my treatment. In an exemplary embodiment, the patient portal requires a security pass code. In an exemplary embodiment, the graphical user interface further includes a first graphical user interface comprising current medical data for a corresponding patient; and a second graphical user interface comprising the current medical data and corresponding historical medical data; wherein the second graphical user interface appears when a pointer is positioned over the current medical data of the first graphical user interface. In an exemplary embodiment, the second graphical user interface further comprises an indication of which of the current and historical medical data that are associated with a corresponding medical treatment.

Although the invention has been described with reference to specific embodiments, these descriptions are not meant to be construed in a limiting sense. Various modifications of the disclosed embodiments, as well as alternative embodiments of the invention will become apparent to persons skilled in the art upon reference to the description of the invention. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims. It is therefore, contemplated that the claims will cover any such modifications or embodiments that fall within the scope of the invention.

1-163. (canceled)

164. A method for simulating surgery on a human patient, comprising obtaining an image of a virtual patient by a method comprising.
a) obtaining, using a computer, a plurality of patient medical data of a patient;
b) generating, using the computer, an at least three-dimensional virtual patient using the plurality of patient medical data, wherein the virtual patient is specific to the patient; and
c) displaying, using the computer, an image of the virtual patient on a device for interaction with a user, wherein the plurality of patient medical data comprises a first diagnostic image that comprises a plurality of anatomic structures, and wherein generating the virtual patient using the plurality of patient medical data comprises:
(i) recognizing at least a first anatomic structure illustrated in the first diagnostic image, and
(ii) using the identified first anatomic structure as a reference point for identifying one or more other anatomic structures within the first diagnostic image on which the simulated surgery may be performed.

165. The method of claim 164, wherein the plurality of patient medical data comprises information from at least one diagnostic test, or wherein the plurality of patient medical data is obtained at various time periods, and is sortable by the various time periods.

166. The method of claim 164, wherein the virtual patent is generated using the plurality of patient medical data by associating a portion of the plurality of patient medical data with the at least one distinguishable anatomic structure.

167. The method of claim 166, wherein generating a virtual patent using the plurality of patient medical data comprises instructions to highlight the at least one distinguishable anatomic structure.

168. The method of claim 164, wherein the plurality of patient medical data comprises current medical data, historical medical data, or a combination thereof.

169. The method of claim 168, wherein the plurality of patient medical data comprises: a) one or more heredity traits of one or more parents or one or more siblings of the patient, b) one or more diseases or medical conditions of one or more parents or one or more siblings of the patient; or c) any combination thereof

170. The method of claim 164, wherein generating a virtual patient using the plurality of patient medical data comprises providing diagnostic information obtained from one or more clinical tests of at least a first biological fluid or a tissue of the patient.

171. The method of claim 164, wherein a portion of the plurality of patient medical data is obtained from a positioning device comprising a scope located within the patient, such that the positioning device provides location information for a plurality of anatomic structures of the patient with respect to the positioning device.

172. The method of claim 171, wherein the positioning device is a GPS device.

173. The method of claim 164, wherein a portion of the plurality of patient medical data comprises diagnostic imaging data obtained from one or more X-rays, CT scans, PET scans, or any combination thereof.

174. The method of claim 164, wherein a portion of the plurality of patient medical data comprises DICOM data.

175. The method of claim 164, wherein the plurality of patient medical data is stored in a database.

176. The method of claim 175, wherein the database may be stored locally or remotely, and accessed, used, or manipulated by a common set of applications.

177. The method of claim 164, wherein the plurality of patient medical data is specific to a single patient, or includes an aggregate of data from more than one patient.

178. The method of claim 164, further comprising performing at least one surgical procedure on the human patient using at least a portion of the information that comprises the virtual patient.

179. A method for planning a medical treatment or procedure for a human patient, comprising obtaining an image of a virtual patient by a method comprising. a) obtaining, using a computer, a plurality of patient medical data of a patient;
b) generating, using the computer, at least a three-dimensional virtual patient using the plurality of patient medical data, wherein the virtual patient is specific to the patient; and
c) displaying, using the computer, an image of the virtual patient on a device for interaction with a user, wherein the plurality of patient medical data comprises a first diagnostic image that comprises a plurality of anatomic structures, and wherein generating the virtual patient using the plurality of patient medical data comprises;
(i) recognizing at least a first anatomic structure illustrated in the first diagnostic image, and
(ii) using the identified first anatomic structure as a reference point for identifying or locating at least one additional anatomic structure within the virtual patient; and
d) using at least one image of the virtual patient as a reference to guide or assist in planning of a medical treatment or procedure on the corresponding additional anatomic structure within the human patient.

180. A method to improve the teaching or the researching of human anatomy, comprising obtaining an image of a virtual patient by a method comprising.
a) obtaining, using a computer, a plurality of patient medical data of a patient;
b) generating, using the computer, at least a three-dimensional virtual patient using the plurality of patient medical data, wherein the virtual patient is specific to the patient; and
c) displaying, using the computer, an image of the virtual patient on a device for interaction with a user,
wherein the plurality of patient medical data comprises a first diagnostic image that comprises a plurality of anatomic structures, and wherein generating the virtual patient using the plurality of patient medical data comprises:
(i) recognizing at least a first anatomic structure illustrated in the first diagnostic image, and
(ii) using the identified first anatomic structure as a reference point for identifying or locating at least one additional anatomic structures within the virtual patient; and
d) using at least one image of the virtual patient as a reference guide or an educational tool to aid or assist in the teaching or the researching of the human anatomy.

181. A method for performing surgery on a human patient, comprising obtaining an image of a virtual patient by a method comprising.
a) obtaining, using a computer, a plurality of patient medical data of a patient;
b) generating, using the computer, at least a three-dimensional virtual patient using the plurality of patient medical data, wherein the virtual patient is specific to the patient; and
c) displaying, using the computer, an image of the virtual patient on a device for interaction with a user,
wherein the plurality of patient medical data comprises a first diagnostic image that comprises a plurality of anatomic structures, and wherein generating the virtual patient using the plurality of patient medical data comprises:
(i) recognizing at least a first anatomic structure illustrated in the first diagnostic image, and
(ii) using the identified first anatomic structure as a reference point for identifying or locating a first surgical site within the virtual patient; and
d) using at least one image of the virtual patient as a reference to guide or assist in performing surgery on the corresponding surgical site within the human patient.
